(19) United States
(12) Patent Application Publication
(10) Pub. No.: US 2017/0002983 A1
(43) Pub. Date: Jan. 5, 2017

(54) VALVE FOR A PRESSURIZED FLUID CYLINDER AND CORRESPONDING CYLINDER

(71) Applicant: L'AIR LIQUIDE, SOCIETE ANONYME POUR L'ETUDE ET L'EXPLOITATION DES PROCEDES GEOGES CLAUDE, Paris (FR)

(72) Inventors: Amélie CARRON, Paris (FR); Beatriz LOPEZ, Paris (FR); Christophe Roland REZEL, Savigny sur Orge (FR); Philippe RUDNIANYN, Villiers sur Orge (FR); Catherine VIVIER, Saint-Egreve (FR)

(21) Appl. No.: 15/113,100

(22) PCT Filed: Jan. 6, 2015
(86) PCT No.: PCT/FR2015/050011

§ 371 Date: Jul. 21, 2016

(30) Foreign Application Priority Data
Jan. 22, 2014 (FR) 1450528

(51) Int. Cl. F17C 13/02

(52) U.S. Cl. CPC F17C 13/025; F17C 2221/011; F17C 2223/0123; F17C 2250/032; F17C 2250/034; F17C 2250/0408; F17C 2250/043; F17C 2250/0439; F17C 2250/0694; F17C 2250/075; F17C 2260/038; F17C 2270/025; F17C 2201/0104

(57) ABSTRACT

The invention relates to a valve for a pressurized fluid cylinder comprising a draw off circuit, a data acquisition, storage, and processing member, at least one display and a pressure sensor for measuring the pressure within the storage space of a fluid cylinder connected to the valve. When the variation of the signal representing the fluid pressure measured by the pressure sensor is greater than a specific draw off threshold, the data acquisition, storage and process member is designed to detect the drawing off of gas and, in response, to control the displaying on the display of at least one item of information concerning the draw off.

### CROSS REFERENCE TO RELATED APPLICATIONS

This application is a 371 of International PCT Application PCT/FR2015/050011 filed Jan. 6, 2015 which claims priority to French Patent Application No. FR 1450528 filed Jan. 22, 2014, the entire contents of which are incorporated herein by reference.

### BACKGROUND

The present invention relates to a valve for a pressurized fluid cylinder and to a corresponding cylinder.

### SUMMARY

The invention relates more particularly to a valve for a pressurized fluid cylinder, comprising a body provided with an end intended to be mounted in the orifice of a cylinder, the body of the valve accommodating at least one withdrawing circuit comprising a first, upstream end intended to communicate the storage volume of a pressurized fluid cylinder and a second, downstream end intended to be connected to a consumer of the withdrawn gas, said at least one circuit comprising an isolating member for opening or closing said withdrawing circuit, the valve comprising an electronic device for indicating data relating to the fluid content in a cylinder connected to the valve, the electronic indicating device comprising a member for acquiring, storing and processing data and at least one data display connected to the member for acquiring, storing and processing data, the valve also comprising a pressure sensor intended to measure the pressure within the storage volume of a fluid cylinder connected to the valve, the pressure sensor being connected to the member for acquiring, storing and processing data in order to transmit to the latter a signal indicative of the measured fluid pressure.

The invention relates to a valve provided with an electronic device for indicating physical data relating to the content notably of pressurized gas in a pressurized fluid cylinder. The invention relates notably to a device known as an electronic digital pressure gage device. Reference may be made for example to the document FR2868160A1, which describes an example of such a device.

Such a device comprises a pressure sensor and an electronic logic which calculates and displays the data relating to the quantity of fluid and/or to autonomy.

In order to calculate and display such reliable autonomy information, the device has to take several successive pressure measurements before evaluating the flow rate selected by the valve user. This causes a calculating time which does not make it possible to immediately display a selected autonomy or withdrawing rate. Thirty to sixty seconds may be necessary, for example. In addition, this device also has an identical reaction time if the withdrawing parameters are changed (change in the selected withdrawing rate, etc.).

In addition, a pressurized fluid cylinder (containing notably oxygen gas) can be used for different applications (supplying a ventilator or directly supplying a patient). In some cases, the known devices cannot usefully inform users.

Such a device furthermore cannot signal certain hazardous situations or certain failures.

It is an aim of the present invention to remedy all or some of the abovementioned drawbacks of the prior art.

To this end, the valve according to the invention, which is otherwise in accordance with the generic definition thereof given in the preamble above, is essentially characterized in that when the variation in the signal indicative of the fluid pressure measured by the pressure sensor is greater than a given withdrawing threshold, the member for acquiring, storing and processing data is configured to detect gas withdrawal and, in response, to cause at least one information item relating to said withdrawal to be displayed on the display.

This makes it possible to rapidly and automatically indicate to the user that gas is being withdrawn, either on account of a medical ventilator being supplied, or on account of a leak.

Moreover, embodiments of the invention can include one or more of the following features:
the variation in the signal indicative of the fluid pressure measured by the pressure sensor is greater than said withdrawing threshold, the member for acquiring, storing and processing data is configured to detect, from the pressure sensor signal, at least one characteristic of the form of the variation in fluid pressure in the cylinder on account of the withdrawal,
said characteristic of the form of the variation in fluid pressure in the bottle comprises at least one of: a periodic character of the variation in pressure or quantity, the frequency of the variation in pressure or quantity,
the member for acquiring, storing and processing data is configured to detect withdrawal corresponding to the fluid supply of a medical ventilator from said characteristic of the form of the variation in fluid pressure in the cylinder, and to cause at least one corresponding information item relating to the fluid supply of a medical ventilator to be displayed on the display,
the member for acquiring, storing and processing data is configured to detect withdrawal corresponding to the fluid supply of a medical ventilator from said characteristic of the form of the variation in fluid pressure in the cylinder, and to cause at least one corresponding information item relating to the fluid supply of a medical ventilator to be displayed on the display,
the valve comprises a first and a second withdrawing circuit, the first withdrawing circuit each comprising a first, upstream end intended to communicate the storage volume of a pressurized fluid cylinder and a second, downstream end intended to be connected to a consumer of the withdrawn gas, the first withdrawing circuit comprising a member for regulating the flow rate and/or the pressure of the withdrawn fluid between its upstream end and downstream end, the valve comprising a member for manually controlling the regulating member, the control member being mounted so as to be able to move relative to the body of the valve and cooperating with the regulating member to control the flow rate and/or pressure of fluid allowed to circulate from the upstream end to the downstream end depending on the position of the control member with respect to the body, the regulating member being movable between at least one open position of the circuit and a position known as the “closed” position corresponding to closure of the first withdrawing circuit, the flow rate of fluid allowed to pass from the upstream end to the downstream end being zero in the closed position of the regulating member, that is to say that the isolating member of the first circuit comprises the regulating member, the valve having a sensor for sensing the position of the regulating member, said position sensor being connected to the member for acquiring, storing and processing data in order to transmit to the latter a signal indicative of its open or closed position, the second withdrawing circuit comprising a portion bypassing the flow rate and/or pressure regulating member of the first withdrawing circuit, and, when the regulating member is in its closed position and the variation in the signal indicative of the fluid pressure within a bottle is greater than the withdrawing threshold, the member for acquiring, storing and processing data is configured to detect withdrawal of fluid via the second withdrawing circuit or via a leak of fluid and to cause an information item relating to this detected withdrawal to be displayed on the display,
the sensor for sensing the position of the isolating member measures or detects the position of the member for manually controlling the regulating member, the position sensor being connected to the member for acquiring, storing and processing data in order to transmit to the latter a signal indicative of the fluid flow rate and/or pressure set by the regulating member from the detected position of the control member,
in response to the signal of the set flow rate and/or pressure measured by the position sensor and to the signal of the pressure measured by the pressure sensor, the member for acquiring, storing and processing data is configured to calculate and display on the display an information item relating to the mode of use of the valve (withdrawal via the first withdrawing circuit or via the second withdrawing circuit) and optionally an information item relating to a possible leak,
when the regulating member is in its closed position and the variation in the signal indicative of the fluid pressure measured by the pressure sensor is lower than the withdrawing threshold, the member for acquiring, storing and processing data is configured to cause a fixed information item relating to the pressure and/or quantity of fluid in the cylinder to be displayed on the display,
the withdrawing threshold corresponds to a value of between 5 and 15 mbar/minute and preferably equal to 10 mbar/minute (0.05 l/min),
when the regulating member is in its closed position and the variation in the signal indicative of the fluid pressure is greater than the withdrawing threshold, the member for acquiring, storing and processing data is configured to calculate an information item relating to the autonomy of remaining fluid from the measurement of the initial-pressure signal and the variation, from this pressure signal output by the pressure sensor, and in that the member for acquiring, storing and processing data is configured to cause this calculated autonomy information item and/or an information item relating to the initial quantity or pressure of fluid in the cylinder to be displayed on the display,
all or some of the detected and/or calculated information is displayed on the display and/or transmitted in a wired or wireless manner by an electrical signal and/or signaled audibly.
at least one of the components and notably one of the sensors (position sensor, pressure sensor) is of the electrical type and powered by a battery and/or an inductive system, said at least one component being able to be powered non-continuously in order to save energy, it being possible for the member for acquiring, storing and processing data to be configured to ensure this power supply when a measurement is taken.

The invention also relates to a cylinder comprising a valve according to any one of the above or following features.

The invention can also relate to any alternative device or method comprising any combination of the above or following features.

### BRIEF DESCRIPTION OF THE DRAWINGS

Further particular features and advantages will become apparent from reading the following description, which is given with reference to the figures, in which:

FIG. 1 shows a schematic and partial side view illustrating a valve mounted on a pressurized gas cylinder according to one possible exemplary embodiment of the invention,

FIG. 2 schematically and partially illustrates the structure and operation of a part of the valve from FIG. 1,

FIGS. 3 to 5 schematically and partially illustrate the structure and operation of three respective examples of position sensors of a valve according to the invention,

FIG. 6 schematically shows two curves illustrating examples of signals generated by one or more position sensors from FIG. 5,

FIGS. 7 and 8 schematically and partially illustrate the structure and operation of a fourth example and a fifth example, respectively, of a position sensor of the valve according to the invention,

FIG. 9 schematically shows an example of a pressure curve measured over time.

### DESCRIPTION OF PREFERRED EMBODIMENTS

FIG. 1 schematically shows a pressurized gas cylinder 2 provided with a valve 1 that is able to implement the invention.

The valve 1 comprises a body provided with an end intended to be mounted in the orifice of a pressurized fluid cylinder 2 (for example by screwing).

In a conventional manner, the body of the valve accommodates at least one withdrawing circuit 11 comprising a first, upstream end intended to communicate the storage volume of a pressurized fluid cylinder and a second, downstream end intended to be connected to a consumer of the withdrawn gas, for example via a self-sealing outlet connection valve 101, i.e. one incorporating a closure valve which is opened by a withdrawal connector connected thereto (for example via a toothed connector).

This valve incorporated into the outlet connection 101 thus forms an isolating member for opening or closing said withdrawing circuit 11. Of course, instead of or in addition to this valve, a separate isolating valve can be provided in the circuit 11. Similarly, and as shown in FIG. 1, a flow rate regulator or a relief valve 14 can be provided in this circuit 11.

This withdrawing circuit 11 is provided for example to supply a gas at a regulated pressure (via a pressure relief valve 14). For example, the second withdrawing circuit 11 supplies a variable or fixed pressure of around 3 to 10 bar to a user appliance.

The valve also comprises an electronic device 6 for indicating data relating to the content of fluid in a cylinder connected to the valve 1.

The electronic indicating device 6 preferably comprises a member 7 for acquiring, storing and processing data and at least one data display 8 connected to the member 7 for acquiring, storing and processing data. The member 7 for acquiring, storing and processing data comprises for example a computer and/or a microprocessor or any other equivalent system. Of course, this device can have one or more data receiving members (via a wired and/or wireless connection) and also one or more data output members (via a wired and/or wireless connection).

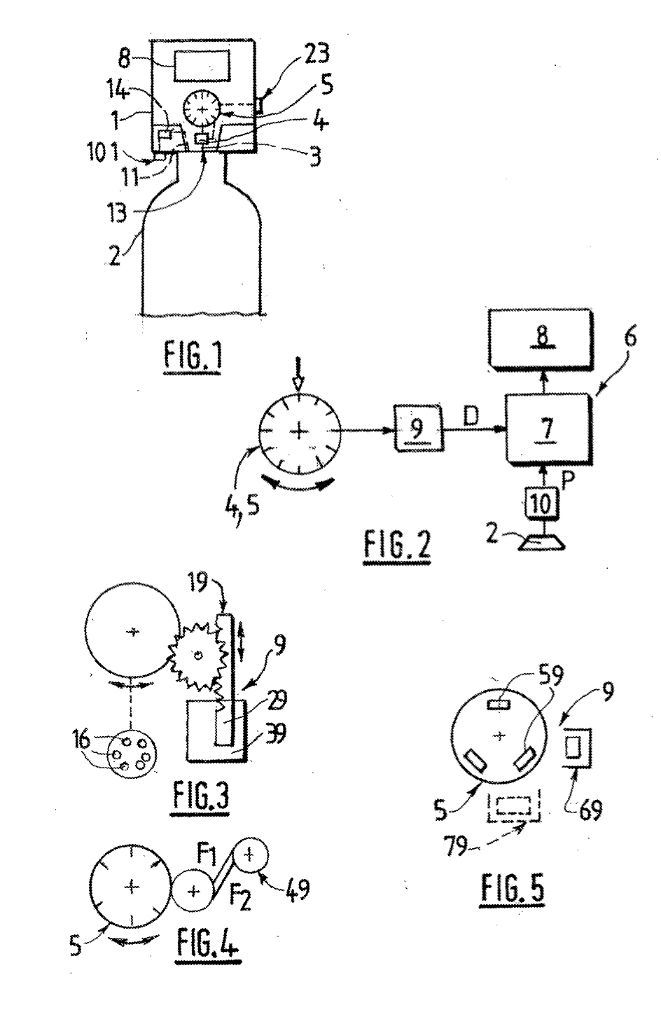

The valve also comprises a pressure sensor 10 intended to measure the pressure within the storage volume of a fluid cylinder 2 connected to the valve 1 (cf. FIG. 2).

The pressure sensor 10 is connected to the member 7 for acquiring, storing and processing data in order to transmit to the latter (in a wired and/or wireless manner) a signal indicative of the fluid pressure measured, notably in real time or periodically.

According to one advantageous feature, when the variation in the signal indicative of the fluid pressure measured by the pressure sensor 10 is greater than a given withdrawing threshold (a minimum threshold), the member 7 for acquiring, storing and processing data is configured to detect gas withdrawal and, in response, to cause at least one information item relating to said withdrawal to be displayed on the display 8. In other words, the member 7 for acquiring, storing and processing data makes it possible to detect withdrawal and to inform the user in a relevant manner.

Preferably, when the variation in the signal indicative of the fluid pressure measured by the pressure sensor 10 is greater than said withdrawing threshold, the member 7 for acquiring, storing and processing data is configured to detect, from the pressure sensor 10 signal, at least one characteristic of the form of the variation in fluid pressure in the cylinder on account of the withdrawal.

The at least one characteristic of the form of the variation in fluid pressure in the cylinder comprises for example one of: a periodic character of the variation in pressure or quantity, the frequency of the variation in pressure or quantity (cf. FIG. 9, which illustrates an example of the variation in pressure P over time).

In other words, the member 7 for acquiring, storing and processing data may be configured to detect withdrawal corresponding to the fluid supply of a medical ventilator from said characteristic of the form of the variation in fluid pressure in the cylinder, and to cause at least one corresponding information item relating to the fluid supply of a medical ventilator to be displayed on the display 8. This makes it possible to usefully inform a user notably by indicating to him that the cylinder is supplying a medical ventilator. The member 7 for acquiring, storing and processing data can supply relevant information relating to this use.

As illustrated in FIG. 1, the body of the valve 1 can accommodate another withdrawing circuit 3 (at least partially separate from the preceding circuit 11) comprising a first, upstream end 13 communicating with the storage volume of the cylinder 2. This withdrawing circuit 3 can comprise a second, downstream end 23 intended to be connected to a consumer of the withdrawn gas (for example a patient in the case of oxygen or some other medical gas).

This withdrawing circuit 3 preferably comprises a member 4 for regulating the flow rate and/or the pressure of the withdrawn fluid between the upstream end 13 and downstream end 23. This regulating member 4 is for example a flow rate regulator having calibrated orifices 16, making it possible to select a withdrawn gas flow rate (cf. the schematic depiction in FIG. 3). Of course, any other regulating member is conceivable.

The valve 1 comprises a member 5 for manually controlling the regulating member 4. The control member 5 is mounted so as to be able to move relative to the body of the valve 1 and cooperates with the regulating valve 4 to control the flow rate and/or pressure of fluid allowed to circulate depending on the position of the control member 5 with respect to the body of the valve. The control member 5 comprises for example a rotary hand wheel. Of course, any other appropriate system is conceivable (pivoting lever, digital control, wireless control via a remote control, etc.). For example, the control member 5 selects a calibrated orifice and/or controls a flow rate restriction valve depending on its position among a plurality of separate stable positions or a plurality of positions on a continuous movement.

The valve 1 can advantageously have a sensor 9 for sensing the position of the member 5 for manually controlling the regulating member 4. The position sensor 9 is connected to the member 7 for acquiring, storing and processing data in order to transmit to the latter a signal indicative of the fluid flow rate and/or pressure set by the regulating member 4. For example, the sensor 9 for sensing the position of the control member 5 comprises a converter for converting the mechanical movement of the control member into an electrical signal that is exploitable by the member 7 for acquiring, storing and processing data.

The detector is for example secured to a fixed part of the valve or, respectively, the control member, the detector 69, 79 outputting an electrical or digital signal determined depending on the position of the control member 5. This signal can be output in a wired and/or wireless manner.

The sensor 9 for sensing the position of the control member 5 can comprise for example at least one of: a capacitive sensor, a magnetic sensor, a mechanical sensor.

The member 7 for acquiring, storing and processing data can be configured to calculate and display on the display 8 an information item relating to the autonomy or content of remaining fluid in response to the reception of the pressure signal delivered by the sensor 10.

Preferably, the member 5 for manually controlling the regulating member 4 is movable into a position known as the “closed” position corresponding to closure of the withdrawing circuit 3 in question. In other words, the flow rate of fluid allowed to pass from the upstream end 13 to the downstream end 23 is zero. When the manual control member 5 is in its closed position and the variation in the signal indicative of the fluid pressure within a cylinder 2 is lower than a given variation threshold (for example equivalent to a pressure drop of 10 mbar/min (0.05 l/min) measured by the pressure sensor 10), the member 7 for acquiring, storing and processing data is preferably configured to cause a fixed information item relating to the pressure and/or quantity of fluid in the cylinder 2 to be displayed on the display 8.

In other words, the device detects that the cylinder 12 is not being emptied and displays for example an information item relating to its content.

When the regulating member 4 is not shared by the two withdrawing circuits 3, 11, withdrawal via one 11 of the circuits is possible, even if this regulating member 4 is in the closed position.

The withdrawing circuit 11 can for example withdraw gas from the cylinder 2 independently of the withdrawing circuit 3 provided with the regulating member 4.

Thus, when the manual control member 5 is in its closed position and the variation in the signal indicative of the fluid pressure within a cylinder 2 (measured by the pressure sensor 10) is greater than a given variation threshold (for example 25 mbar per minute), the member 7 for acquiring, storing and processing data can detect withdrawal of fluid via the second withdrawing circuit 11 or, if this second withdrawing circuit 11 is not being used, signal a possible leak of fluid.

The member 7 for acquiring, storing and processing data can, if need be, cause an information item relating to withdrawal via the withdrawing circuit 11 and or relating to a leak (warning signal) to be displayed on the display 8 or to be output (wirelessly, in a wired manner or audibly).

In particular, when the manual control member 5 is in its position known as the closed position and the variation in the signal indicative of the fluid pressure within a cylinder is greater than a given variation threshold (for example 25 mbar per minute), the member 7 for acquiring, storing and processing data can be configured to detect at least one characteristic of the form of the variation in fluid pressure in the cylinder on account of the withdrawal via the withdrawing circuit 11 in question (as previously described).

As illustrated schematically in FIG. 9, this makes it possible to detect, at the end of two to three pressure oscillations, for example periodic withdrawal corresponding to a gas supply to a respiratory ventilator. Specifically, even if the gas withdrawn does not pass through the flow rate regulator 4, the flow rate is regulated directly by a ventilator and depends on the patient's breathing. This flow rate thus delivered is not constant but oscillates over time (depending on the patient's breathing).

The member 7 for acquiring, storing and processing data can be configured to detect (recognize) a drop in pressure characteristic of ventilation using the following principle:
measuring the pressure signal in a close periodic manner (for example every 0.1 to two seconds, notably every second),
identifying a signal of the square wave type with a frequency of five to twenty-five square waves (respirations) per minute.

In order to calculate the remaining gas autonomy from such a signal, the member 7 for acquiring, storing and processing data can be configured to measure the pressure drop over the optima in order to deduce therefrom the equivalent rate of decrease (cf. reference 15 in FIG. 9). Alternatively or in addition, the member 7 for acquiring, storing and processing data can be configured to work out the average drop in pressure over a relatively long time (several minutes, for example ten minutes) so as to remove image inaccuracies.

In the event that this pressure signal does not correspond to a ventilation signal (for example a continuous decreasing variation), the member 7 for acquiring, storing and processing data can determine that it is a leak or incorrect use of the gas, and can signal this in the same way.

Thus, in this case, the simultaneous detection of the closed position (scale “0”=“zero” for example) at the position detector 5 and a pressure drop, it is then possible to instantaneously and automatically detect the mode of use of the cylinder 2. An autonomy calculation algorithm appropriate for this manner of withdrawal can be carried out by the member 7 for acquiring, storing and processing data.

This autonomy calculation algorithm based on the pressure measurement 10 can then be initiated automatically.

In addition, when the manual control member 5 is in its closed position and the variation in the signal indicative of the fluid pressure within a cylinder 2 is greater than a given variation threshold, the member 7 for acquiring, storing and processing data can be configured to calculate an information item relating to the autonomy of remaining fluid from the measurement of the initial-pressure signal and the variation in this pressure signal provided by the pressure sensor 10. The member 7 for acquiring, storing and processing data can notably be configured to cause this calculated autonomy information item and/or an information item relating to the initial quantity or pressure of fluid in the cylinder 2 to be displayed on the display 8.

The pressure sensor 10 can be situated for example at the upstream end of the first withdrawing circuit 3 and/or at the second withdrawing circuit 11.

In addition, the member 7 for acquiring, storing and processing data can be configured to cause an information item relating to the fluid flow rate and/or pressure set by the regulating member 4 to be displayed on the display 8 in response to the reception of this set flow rate and/or pressure signal.

As illustrated in FIG. 3, the sensor 9 for sensing the position of the control member 5 can comprise for example a mechanism 19 that meshes with the control member 5 (a meshing and/or notching system) and a potentiometer 39. The mechanism has a moving part 29 (for example a wheel or a rod or a rack) that forms a wiper of the potentiometer 39. In this way, the position sensor 9 supplies a voltage and/or resistance value determined depending on the position of the control member 5.

In the example in FIG. 4, the sensor 9 for sensing the position of the control member 5 comprises a mechanism that meshes with the control member 5 comprising an optical and/or digital encoder 49, for example a wired encoder (live wire and ground wire). The encoder 49 supplies a digital signal determined depending on the position of the control member 5. Depending on the position of the mechanism, one or more wires are live or short-circuited, forming a plurality of separate signals for characterizing different positions (for example 2ⁿ⁻¹ for a system having n wires).

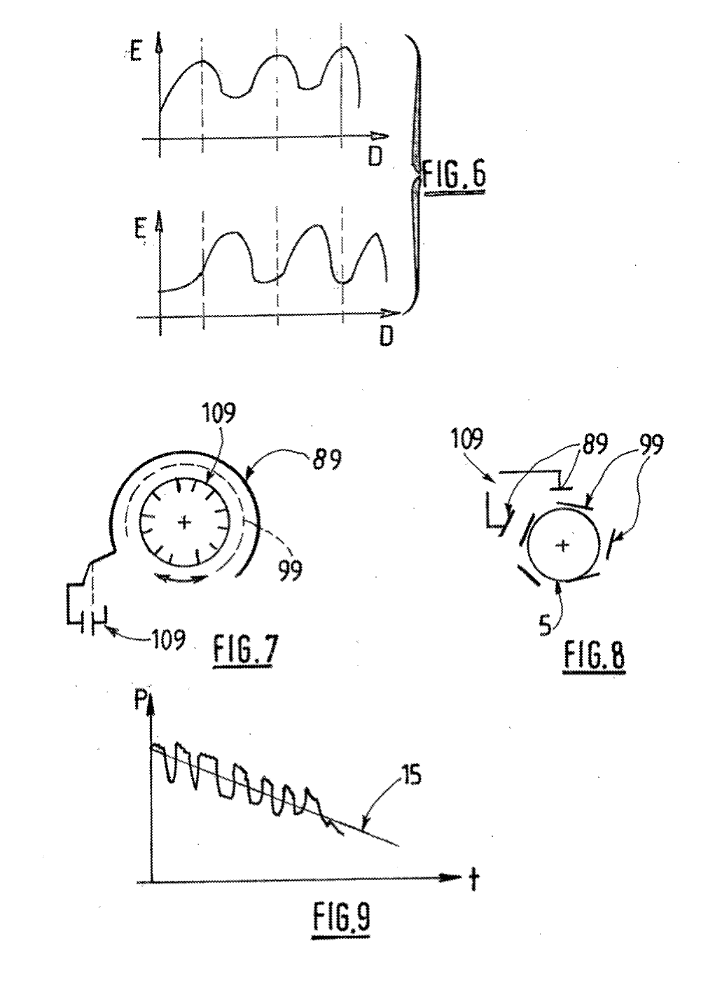

As illustrated in FIG. 5, the sensor 9 for sensing the position of the control member 5 can comprise a magnetic system having at least one magnet 59 secured to the control member 5 and at least one detector 69, 79 for detecting the magnetic field of the at least one magnet 59. For example three magnets 59 are secured to the control member 5. If the control member 5 moves (such as by rotation), one detector 69 detects for example a magnetic field E depending on the movement D which oscillates and makes it possible to characterize a plurality of positions. When the device comprises a second detector 79 (or more), several separate signals can be exploited simultaneously in order to improve the detection of the separate positions.

As illustrated in FIGS. 7 and 8, the sensor 9 for sensing the position of the control member 5 can comprise a capacitive system 109 that measures an electrical capacitance between a fixed magnetic reference 89 and a moving part 99 connected to the control member 5.

All of these systems have the advantage of reliable detection without the need to provide electric wires linked to a moving part of the mechanism.

The potentiometer system and more generally each detection system can be calibrated easily during production.

For example, the potentiometer 39 or detector of the sensor 9 for sensing the position of the control member 5 can be calibrated by measuring the voltage or resistance value (or magnetic field and capacitance value) which it supplies and corresponds to said closed position (zero flow rate). Next, it is possible to measure the voltage or resistance value supplied by the potentiometer 39 which corresponds to an extreme position of the control member 5 with respect to the closed position (for example 15 liters/minute). The intermediate voltage or resistance values supplied by the potentiometer 39 are attributed respectively to the intermediate positions of the control member 5 between the closed position and the extreme position. (Likewise for the detection of some other physical variable, magnetic field, capacitance, etc., where the intermediate positions of the signal can be allocated respectively to the intermediate positions of the control member 5).

Alternatively or in addition, the potentiometer 39 of the sensor 9 for sensing the position of the control member 5 can be calibrated by measuring the voltage or resistance value that it supplies corresponding to a position of the control member 5 in which no pressure variation is measured by the pressure sensor 10 for a given time, for example one to three minutes. This position (this value of the signal) is defined as being the closed position of the circuit (zero flow rate). This way of defining the closed position can be applied to the other examples (magnetic field, capacitance, etc.).

The member 7 for acquiring, storing and processing data can thus be configured to receive both the signal of pressure P measured by the pressure sensor 10 and the flow rate and/or pressure D signal supplied by the position sensor 9. The member 7 for acquiring, storing and processing data can thus be programmed to calculate an information item relating to the autonomy of remaining fluid from these two information items, the autonomy of remaining fluid being determined by calculating, from the initial pressure measured, the theoretical decrease over time in pressure or the quantity of gas generated by the withdrawing flow rate and/or pressure D set by the regulating member 4.

In addition, the member 7 for acquiring, storing and processing data can be configured to:
calculate the actual variation in fluid quantity or pressure measured by the pressure sensor 10,
calculate the theoretical variation in fluid quantity or pressure set by the regulating member 4,
compare the actual variation in quantity or pressure measured by the pressure sensor 10 with the theoretical variation in quantity or pressure set by the regulating member 4, and
generate a warning signal if the theoretical and actual variations diverge to an extent greater than a given safety threshold (for example diverge by 15 to 30%, and notably 25%).

The information relating to the autonomy or content of fluid remaining in the cylinder 2 can be expressed in time remaining (or, respectively, in quantity remaining) by dividing the initial pressure measured by the pressure sensor 10 (or, respectively, a quantity of gas flowing) by the theoretical variation in pressure set by the regulating member 4 (or, respectively, the variation in quantity set by the regulating member (4)), by a formula for example of the type: Time remaining=Initial pressure/variation in pressure set (or, respectively: Time remaining=Remaining fluid content/variation in quantity set).

The theoretical variations in quantity or pressure can be calculated for example via the perfect gas equation PV=nRT or real gas equation PV=ZnRT (S.I. units), where P is the pressure measured, V the known volume of the cylinder, n the quantity, R the perfect gas constant and T the temperature measured or approximated to the ambient temperature measured, Z the compressibility factor presumed to be known (table or calculation). Similarly, the conversions between pressure and quantity can be calculated via the perfect gas equation or any other equivalent formula, the volume of the cylinder 2 being known and entered in the member 7 for acquiring, storing and processing data and the temperature can be measured by a sensor in the cylinder or an ambient external sensor or calculated or entered or approximated.

The member 7 for acquiring, storing and processing data can be configured to calculate an information item relating to the autonomy or content of fluid over a given period of time of between fifteen seconds and ten minutes, and preferably between thirty seconds and five minutes, from the signal of pressure measured by the pressure sensor 10. The member 7 for acquiring, storing and processing data can also be configured to compare this autonomy information calculated on the basis of the measured pressure P signal with the theoretical autonomy information calculated from the variation in quantity or pressure set by the regulating member 4.

The dynamic pressure measurement can make it possible to adjust the display of the effective flow rate withdrawn and/or the autonomy displayed more precisely, if necessary.

Similarly, the member 7 for acquiring, storing and processing data can be configured to recalculate and display optionally automatically an update of the information relating to the autonomy or content of fluid on receiving a signal from the position sensor 9 indicating a change in fluid flow rate and/or pressure set by the regulating member 4 via the control member 5.

The manual control member 5 and/or the regulating member 4 may be able to move into a plurality of separate positions (which are or are not mechanically stable) that correspond to respective flow rate and/or pressure values of fluid allowed to pass from the upstream end 13 to the downstream end. According to one possible advantageous particular feature, when the manual control member 5 is disposed in an intermediate position between two respective adjacent flow rate and/or pressure values of fluid allowed to pass from the upstream end 13 to the downstream end 23, the member 7 for acquiring, storing and processing data is configured to select and display on the display 8 one or both of these adjacent values, and preferably most critical or most unfavorable value for the user.

Alternatively, in this situation, the member 7 for acquiring, storing and processing data can be configured to display on the display 8 a range of values delimited by these adjacent values or to suppress all or some of the display of these values.

This makes it possible to ergonomically warn the user of incorrect manipulation by displaying relevant but disadvantageous information, obliging him to correct his selection (or by suppressing this display).

For example, when the manual control member 5 is disposed in an intermediate position between two respective adjacent flow rate values, the member 7 for acquiring, storing and processing data is configured to calculate and display on the display 8 an information item relating to the autonomy or content of fluid remaining in the cylinder on the basis of the higher value of the two adjacent values.

Thus, if, for example, the user positions the control member 5 between the positions n liters per minute and n+1 liters per minute (n being an integer), the member 7 for acquiring, storing and processing data can be configured to calculate autonomy based on the withdrawn flow rate value of n+1 liters per minute (less autonomy than if it had been calculated with the value of n liters per minute).

Similarly, when the manual control member 5 is disposed in an intermediate position between two respective adjacent flow rate values, the member 7 for acquiring, storing and processing data can be configured to display on the display 8 an information item relating to the withdrawn flow rate set by the regulating member 4 that corresponds to the lower value of the two adjacent values. Thus, if, for example, the user positions the control member 5 between the positions n liters per minute and n+1 liters per minute (n being an integer), the member 7 for acquiring, storing and processing data can be configured to display on the display 8 an information item based on the withdrawn flow rate value of n liters per minute (the lower flow rate, which may for example be less than the medical prescription). This will cause the user to react so as to correct the flow rate selection.

The device can be configured to deliver in this case a fluid flow rate corresponding to one of the two adjacent values, notably the displayed value.

In addition, the member 7 for acquiring, storing and processing data can be configured to have a guarantee seal function indicating that the cylinder 2 has not been used after being filled. Thus, before first withdrawal, the member 7 for acquiring, storing and processing data can cause a fixed information item relating to the fluid content in the cylinder 2 (and/or the information item of the “cylinder full” type) to be displayed on the display 8 until the position sensor 9 transmits a signal indicative of a flow rate and/or the pressure of fluid withdrawn from the reservoir 2 for a given time and/or corresponding to a given quantity of fluid (for example 20 liters of gas withdrawn). This detection can be carried out or completed by the information provided by the pressure sensor 10.

Although the invention is relatively simple and inexpensive, it is easy to see that it makes it possible to display flow rate and autonomy information more quickly.

The invention applies advantageously to pressurized gas cylinders, notably cylinders containing pressurized oxygen.

1.-12. (canceled)

13. A valve for a pressurized fluid cylinder, comprising a body provided with an end intended to be mounted in the orifice of a cylinder, the body of the valve accommodating at least a first withdrawing circuit comprising a first, upstream end configured to communicate the storage volume of a pressurized fluid cylinder and a second, downstream end intended to be connected to a consumer of the withdrawn gas, said at least first circuit comprising an isolating member for opening or closing said withdrawing circuit, the valve comprising an electronic device for indicating data relating to the fluid content in a cylinder connected to the valve, the electronic indicating device comprising a member for acquiring, storing and processing data and at least one data display connected to the member for acquiring, storing and processing data, the valve also comprising a pressure sensor intended to measure the pressure within the storage volume of a fluid cylinder connected to the valve, the pressure sensor being connected to the member for acquiring, storing and processing data in order to transmit to the latter a signal indicative of the measured fluid pressure, wherein the member for acquiring, storing and processing data is configured to measure the variation in the signal indicative of the fluid pressure on the basis of the signal supplied by the pressure sensor and to compare this variation in the measured signal with a given withdrawing threshold and, when the variation in the signal indicative of the fluid pressure measured by the pressure sensor is greater than the given withdrawing threshold, the member for acquiring, storing and processing data is configured to detect the start of gas withdrawal and, in response, to cause at least one information item relating to said withdrawal, the flow rate of which has been detected by the pressure sensor, to be displayed on the display, and in that, when the variation in the signal indicative of the fluid pressure measured by the pressure sensor is greater than said withdrawing threshold, the member for acquiring, storing and processing data is configured to detect, from the pressure sensor signal, at least one characteristic of the form of the variation in fluid pressure in the cylinder on account of the withdrawal, said characteristic of the form of the variation in fluid pressure in the bottle comprises at least one of: a periodic character of the variation in pressure or quantity, the frequency of the variation in pressure or quantity, an average of the pressure measurements, the maximum and minimum of the pressure measurements, an average value or instantaneous value of the variation in pressure, and in that the member for acquiring, storing and processing data is configured to compare at least one detected characteristic of the form of the variation in pressure with a given characteristic of the form of the variation in pressure indicative of the gas consumption of a medical ventilator and, when the difference in absolute value between said detected characteristic and the given characteristic is less than a given threshold, to detect withdrawal corresponding to the fluid supply of a medical ventilator and to cause at least one corresponding information item relating to the fluid supply of a medical ventilator to be displayed on the display.

14. The valve of claim 13, wherein the member for acquiring, storing and processing data is configured to detect, from the pressure sensor signal, a periodic or quasi-periodic characteristic of the form of the variation in discontinued pressure, each pressure drop period being between 1.5 and 6 seconds and corresponding to a breathing pattern of 10 to 40 periods per minute.

15. The valve of claim 13, wherein the pressure sensor measures the pressure at a given and variable sampling frequency, and in that the member for acquiring, storing and processing data is configured to increase the measurement sampling frequency of the pressure sensor in response to detection of a start of withdrawal.

16. The valve of claim 15, wherein when no withdrawal is detected, the pressure sensor measures the pressure at a sampling frequency of one measurement every thirty seconds to two minutes, and in that, if withdrawal is detected, the sampling frequency is one measurement every 0.1 to 3 seconds.

17. The valve of claim 15, wherein when withdrawal is detected, the pressure sensor is configured to measure the pressure only during given time periods that are spaced apart by twenty to sixty seconds, each time period lasting for between four and ten seconds, and in that, during each time period, the pressure is measured every 50 ms to 200 ms.

18. The valve of claim 13, further comprising a second withdrawing circuit, the first and second withdrawing circuits each comprising a first, upstream end configured to communicate the storage volume of a pressurized fluid cylinder and a second, downstream end configured to be connected to a consumer of the withdrawn gas, the first withdrawing circuit comprising a member for regulating the flow rate and/or the pressure of the withdrawn fluid between its upstream end and downstream end, the valve comprising a member for manually controlling the regulating member, the control member being mounted so as to be able to move relative to the body of the valve and cooperating with the regulating member to control the flow rate and/or pressure of fluid allowed to circulate from the upstream end to the downstream end of the first withdrawing circuit depending on the position of the control member with respect to the body, the regulating member being movable between at least one open position of the circuit and a position known as the “closed” position corresponding to closure of the first withdrawing circuit, the flow rate of fluid allowed to pass from the upstream end to the downstream end of the first withdrawing circuit being zero in the closed position of the regulating member, the valve having a sensor for sensing the position of the regulating member, said position sensor being connected to the member for acquiring, storing and processing data in order to transmit to the latter a signal indicative of its open or closed position, the second withdrawing circuit comprising a portion bypassing the flow rate and/or pressure regulating member of the first withdrawing circuit, and in that when the regulating member is in its closed position and the variation in the signal indicative of the fluid pressure within a cylinder is greater than the withdrawing threshold, the member for acquiring, storing and processing data is configured to detect withdrawal of fluid via the second withdrawing circuit or via a leak of fluid and to cause an information item relating to this detected withdrawal to be displayed on the display.

19. The valve of claim 18, wherein the sensor for sensing the position of the regulating member measures or detects the position of the member for manually controlling the regulating member, the position sensor being connected to the member for acquiring, storing and processing data in order to transmit to the latter a signal indicative of the fluid flow rate and/or pressure set by the regulating member from the detected position of the control member.

20. The valve of claim 18, wherein in response to the signal of the set flow rate and/or pressure measured by the position sensor and to the signal of the pressure measured by the pressure sensor, the member for acquiring, storing and processing data is configured to calculate and display on the display an information item relating to the mode of use of the valve.

21. The valve of claim 18, wherein when the regulating member is in its closed position and the variation in the signal indicative of the fluid pressure measured by the pressure sensor is lower than the withdrawing threshold, the member for acquiring, storing and processing data is configured to cause a fixed information item relating to the pressure and/or quantity of fluid in the cylinder to be displayed on the display.

22. The valve of claim 21, wherein when the regulating member is in its closed position and the variation in the signal indicative of the fluid pressure is greater than the withdrawing threshold, the member for acquiring, storing and processing data is configured to calculate an information item relating to the autonomy of remaining fluid from the measurement of the initial-pressure signal and the variation, from this pressure signal output by the pressure sensor, and in that the member for acquiring, storing and processing data is configured to cause this calculated autonomy information item and/or an information item relating to the initial quantity or pressure of fluid in the cylinder to be displayed on the display.

23. A pressurized fluid cylinder comprising the valve of claim 13.

24. The cylinder of claim 23, wherein the member for acquiring, storing and processing data is configured to calculate and display, from the signal from the pressure sensor, the gas autonomy of the cylinder from a known initial gas pressure in the cylinder and by estimating the pressure drop between similar withdrawing sequences, using one of: an average withdrawing value, a value of the variation in pressure against a plate, the minimum or maximum values of each withdrawing sequence, in order to calculate the drop in pressure between given time sequences, and by estimating the moment at which the gas pressure in the cylinder will be zero.
